(19) United States
(12) Patent Application Publication
(10) Pub. No.: US 2011/0143205 A1
(43) Pub. Date: Jun. 16, 2011

(54) NEGATIVE ELECTRODE ACTIVE MATERIAL FOR NONAQUEOUS SECONDARY BATTERY, NONAQUEOUS SECONDARY BATTERY, AND USING METHOD

(75) Inventors: Yoshinari MAKIMURA, Nisshin-shi (JP); Takao INOUE, Nisshin-shi (JP); Yoji TAKEUCHI, Seto-shi (JP)

(73) Assignee: KABUSHIKI KAISHA TOYOTA CHUO KENKYUSHO, AICHI-GUN (JP)

(21) Appl. No.: 12/966,342

(22) Filed: Dec. 13, 2010

(30) Foreign Application Priority Data
Dec. 15, 2009 (JP) 2009-284049

(51) Int. Cl. H01M 4/52

(52) U.S. Cl. 429/223; 252/182.1

(57) ABSTRACT

A coin type battery 20 is provided with a cup-shaped battery case 21, a positive electrode 22 disposed in the inside of this battery case 21, a negative electrode 23 disposed at a location opposite to the positive electrode 22 with a separator 24 therebetween, a nonaqueous electrolytic solution 27 containing a supporting electrolyte, a gasket 25 formed from an insulating material, and an opening-sealing plate 26, which is disposed at an opening portion of the battery case 21 and which seals the battery case 21 with the gasket 25 therebetween. Here, the negative electrode 23 includes an oxide represented by a basic composition LiNi₁₋ₓMnₓO₂ (0<x<0.5) as a negative electrode active material. It is preferable that the valence of Ni contained in the oxide is 2 and 3, and the valence of Mn is 4.

### BACKGROUND OF THE INVENTION

1. Field of the Invention

The present invention relates to a negative electrode active material for a nonaqueous secondary battery, a nonaqueous secondary battery, and a using method.

2. Description of the Related Art

As for negative electrode active materials for nonaqueous secondary batteries, metal lithium, carbon materials, oxide based materials, and the like have been previously known. Here, as for oxide based materials, a negative electrode material formed from lithium-vanadium complex oxide and the like have been proposed (refer to Japanese Unexamined Patent Application Publication No. 2003-58305, for example). This negative electrode material has a composition satisfying 2>Li/V molar ratio>1.05 and contains a crystal satisfying the ratio c/a≦5.17, where a and c are lattice constants indexed on the basis of a hexagonal system, and it is believed that a good discharge capacity and a good discharge efficiency are exhibited.

### SUMMARY OF THE INVENTION

By the way, the nonaqueous secondary battery has broad uses from personal computers and cellular phones to electric cars, hybrid cars, and the like, and required characteristics may be different depending on the uses. Accordingly, a new negative electrode active material for a nonaqueous secondary battery and a new nonaqueous secondary battery, which can become choices of the negative electrode active material for a nonaqueous secondary battery and the nonaqueous secondary battery, have been required.

The present invention has been made to solve such problems, and it is a main object to provide a new negative electrode active material for a nonaqueous secondary battery, a new nonaqueous secondary battery, and a new using method.

In order to achieve the above-described object, the present inventors produced a secondary battery by using a lithium nickel manganese complex oxide as a negative electrode active material for a nonaqueous secondary battery. As a result, it was found that the resulting secondary battery functioned as a battery and was chargeable and dischargeable. Consequently, the present invention has been completed.

That is, a negative electrode active material for a nonaqueous secondary battery according to the present invention is represented by a basic composition LiNi₁₋ₓMnₓO₂ (0<x<0.5).

A secondary battery by using this negative electrode active material for a nonaqueous secondary battery is chargeable and dischargeable, and can function as a battery. Consequently, it is possible to apply to power supply uses of various apparatuses.

### BRIEF DESCRIPTION OF THE DRAWINGS

FIG. 1 is a sectional view schematically showing the configuration of a coin type battery 20,

FIG. 2 shows the X-ray diffraction pattern of a negative electrode active material for a nonaqueous secondary battery of Experimental example 1,

FIG. 3 shows a charge-discharge curve of the first cycle of the negative electrode active material for a nonaqueous secondary battery of Experimental example 1,

FIG. 4 is a graph showing the relationship between the x value of LiNi₁₋ₓMnₓO₂ and the initial oxidation (discharge) capacity,

FIG. 5 is a graph showing the relationship between the x value of LiNi₁₋ₓMnₓO₂ and the proportion of irreversible capacity,

FIG. 6 is a graph showing the relationship between the x value of LiNi₁₋ₓMnₓO₂ and the oxidation (discharge) capacity maintenance factor,

FIG. 7 is a graph showing the relationship between the x value of LiNi₁₋ₓMnₓO₂ and the energy of an X-ray spectrum at the NiK absorption edge,

FIG. 8 is a graph showing the relationship between the x value of LiNi₁₋ₓMnₓO₂ and the energy of an X-ray spectrum at the MnK absorption edge,

FIG. 9 is a graph showing the relationship between the x value of LiNi₁₋ₓMnₓO₂ and the peak area intensity ratio I(003)/I(104),

FIG. 10 is a graph showing the relationship between the x value of LiNi₁₋ₓMnₓO₂ and the distance D between transition metal layers.

### DESCRIPTION OF THE PREFERRED EMBODIMENTS

A negative electrode active material for a nonaqueous secondary battery according to the present invention is an oxide represented by a basic composition LiNi₁₋ₓMnₓO₂ (0<x<0.5). Here, x is within the range of more than 0, and less than 0.5. In the case where x is within this range, charge and discharge can be performed and it is possible to function as a battery. Furthermore, the charge and discharge capacities can be increased, the irreversible capacity can be reduced, and a cycle characteristic in repeated charge and discharge can be improved. In this case, if x is within the range of more than 0, and 0.15 or less, the initial discharge capacity can be further increased. Moreover, if x is within the range of 0.25 or more, and 0.40 or less, the irreversible capacity can be further reduced and the recycle characteristic in repeated charge and discharge can be further improved. In this regard, a part of Ni and Mn may be substituted (doped) with other elements, e.g., transition metal elements, or the oxide may have not only a stoichiometric composition, but also a nonstoichiometric composition, in which a part of elements become deficient or excess, insofar as the oxide is represented by the above-described basic composition. It is preferable that the other element, which substitutes for a part of Ni and Mn, is at least any one of Mg, Al, and Co. Alternatively, the other element for substitution may be any one of the transition metal elements. Furthermore, in the case where a part of Ni and Mn are substituted, it is preferable that the amount of substitution is more than 0.8 percent by mole, and less than 12 percent by mole of the total amount of Ni and Mn in the basic composition, and 1.0 percent by mole or more, and 10 percent by mole or less is more preferable. By the way, it is believed that in a crystal lattice, Mg in the form of Mg²⁺ is substituted for Ni²⁺, and Al and Co in the forms of Al³⁺ and Co³⁺ are substituted for Ni³⁺.

Regarding the negative electrode active material for a nonaqueous secondary battery, according to the present invention, preferably, the valence of Ni contained in the oxide is 2 and 3, and the valence of Mn is 4. Consequently, the charge and discharge capacities can be increased, the irreversible capacity can be reduced, and a recycle characteristic in repeated charge and discharge can be improved. Here, the valence refers to a formal oxidation number derived from the energy of X-ray spectrum corresponding to the amount of absorption of 0.5, where the X-ray absorption fine structure is measured and the amount of absorption of an absorption local maximum value at the K absorption edge is assumed to be 1. Furthermore, the valence refers to a value measured at an electrode potential within the range of 2.5 V or more, and 3.3 V or less with reference to lithium and is preferably a value measured before first charge after production. Specifically, the formal oxidation number can be derived in the following manner. A measurement of the X-ray absorption fine structure (XAFS) will be described below. This measurement and the principle are described in, for example, “X-Sen Kyuushuu Bisaikouzou-XAFS No Sokutei To Kaiseki (X-Ray Absorption Fine Structure-Measurement and Analysis of XAFS)” (edited by Yasuo Udagawa, 1993). Specifically, when a monochromatic X-ray is applied and passed through a substance, the X-ray absorbance of the substance can be obtained from the intensity of the X-ray applied to the substance (incident intensity: I₀) and the intensity of the X-ray passed through the substance (transmission intensity: Iₜ), and an X-ray absorption spectrum is measured where the energy (eV) of the incident X-ray is changed while the X-ray absorbance is monitored. At this time, there is a point at which the X-ray absorbance increases sharply, and the energy value of X-ray at this point is referred to as an absorption edge. The absorption edge is intrinsic to an element constituting the substance, and a fine oscillatory structure, which appears from the vicinity of this absorption edge to the side of high energy of about 1,000 eV, is referred to as the X-ray absorption fine structure. In particular, the oxidation number of the transition metal ion in the oxide can be examined from the energy of X-ray spectrum corresponding to the amount of absorption of 0.5, where the X-ray absorption near-K-edge structures are measured and the amount of absorption of an absorption local maximum value, which appears near the K absorption edge of the transition metal element, is assumed to be 1. The X-ray absorption near-K-edge fine structures are closely related to the coordination state of the transition metal ions, and it is necessary that an oxide with a layered structure having a cubic close-packed oxygen array is used as a reference sample to calculate the oxidation number strictly. In this regard, here, Li₂MnO₃ is used as the reference sample of Mn⁴⁺, layered structure LiMnO₂ is used as the reference sample of Mn³⁺, LiCO_{0.5}Ni_{0.5}O₂ is used as the reference sample of Ni³⁺, and LiCO_{1/3}Ni_{1/3}Mn_{1/3}O₂ is used as the reference sample of Ni²⁺ and Mn⁴⁺. By the way, C. S Johonson, M. M. Thackeray, et al. show in Chemistry of Materials, 15, 2313-2322, 2003 that Li₂Ni_{0.5}Mn_{0.5}O₂ having a hexagonal close-packed oxygen array is obtained by inserting lithium into LiNi_{0.5}Mn_{0.5}O₂ having a cubic close-packed oxygen array. Furthermore, it is described that Ni³⁺ and Mn³⁺ are not present, but only Ni²⁺ and Mn⁴⁺ are contained in the crystal lattice of the synthesized active material and, therefore, the structure stability and the charge and discharge stability are excellent. On the other hand, it can be said that the negative electrode active material for a nonaqueous secondary battery according to the present invention is different therefrom because of being represented by the composition formula LiNi₁₋ₓMnₓO₂ (0<x<0.5), so as to perform the function. Moreover, regarding the layered oxide, in which Ni and Mn are a combination of Ni²⁺, Ni³⁺, and Mn⁴⁺, in the present invention, it can be said that the idea is different from the idea in the above-described literature because the function is further enhanced by employing such valences.

Regarding the negative electrode active material for a nonaqueous secondary battery according to the present invention, the peak area intensity ratio I(003)/I(104) of the (003) face to the (104) face of the X-ray diffraction peak is preferably less than 1.4, more preferably 1.2 or less, and further preferably 1.1 or less, where the space group is assumed to be R3m. In addition, more than 0.8 is preferable, and 0.9 or more is more preferable. In the case where the peak area intensity ratio is more than 0.8, and less than 1.4, as described above, the initial oxidation capacity can be increased, the proportion of the initial irreversible capacity can be reduced, and a cycle characteristic in repeated charge and discharge can be improved.

Furthermore, it is believed that this negative electrode active material for a nonaqueous secondary battery has a hexagonal system layered structure, and the interlayer distance D (A) is preferably more than 4.727, more preferably 4.733 or more, and further preferably 4.747 or more. Moreover, less than 4.767 is preferable, and 4.760 or less is further preferable. In this regard, this interlayer distance is specified to be a value of the distance D between transition metal layers calculated from the diffraction angles of the individual diffraction peaks and the Miller index through optimization by using a least square method.

A method for manufacturing the negative electrode active material for a nonaqueous secondary battery according to the present invention may include, for example, (1) an adjustment step to adjust raw materials, (2) a mixing step to mix the raw materials by a mechanical alloying method, and (3) a firing step to fire the resulting mixed raw material. In the adjustment step, the raw materials are adjusted in such a way that an oxide having a composition represented by LiNi₁₋ₓMnₓO₂ (0<x<0.5) is obtained. The raw materials are not specifically limited. For example, lithium hydroxide can be used as a Li source, oxides containing Ni, e.g., NiO, can be used as a Ni source, and oxides containing Mn, e.g., MnO, can be used as a Mn source. Furthermore, for example, an oxide of at least any one of Mg, Al, and Co may be added as other elements which are substituted for a part of Ni and Mn. Alternatively, the other element used for substitution may be a transition metal. It is preferable that the amount of this substitution is adjusted to become more than 0.8 percent by mole, and less than 12 percent by mole of the total amount of Ni and Mn in the basic composition, and it is more preferable that the amount is adjusted to become 1.0 percent by mole or more, and 10 percent by mole or less. In the mixing step, initially, the raw materials are mechanically mixed by the mechanical alloying method. Regarding this mechanical alloying method, the degree of mixing of the raw materials can be adjusted and, therefore, the valences of Ni and Mn can be controlled. In the mechanical alloying method, for example, a ball mill, e.g., a planetary ball mill, can be used. Consequently, the degree of mixing can be changed by using various parameters, e.g., the number of revolutions, the time, and the ball diameter. For example, a planetary ball mill apparatus including a zirconium container and zirconium balls may be used, the weight ratio of the balls and the above-described raw materials may be specified to be 40:1, a solvent, e.g., ethanol, may be added to the above-described raw materials, and a treatment may be performed for 24 hours while the number of revolutions of the revolution is specified to be 200 rpm and the ratio of the revolution to the rotation is specified to be 1.25. In the case where the treatment is performed under such conditions, the raw materials are mixed sufficiently, the valences of Ni in the oxide resulting from firing in the downstream can be made 2 and 3, and the valence of Mn can be made 4. Subsequently, the slurry-like mixed raw material resulting from the ball mill treatment is concentrated and dried. The method of concentration and drying is not specifically limited, although it is preferable to use a rotary evaporator. This is because the method by using the rotary evaporator can suppress elution of components and the like as compared with that in the case of filtration or the like. In the firing step, the resulting mixed raw material is fired. In the firing, the resulting mixed raw material may be used after being pressure-formed into the shape of pellets. Preferably, the firing atmosphere is an oxidizing atmosphere, e.g., an air atmosphere or an oxygen atmosphere. Regarding the firing temperature, the optimum temperature is different depending on the composition, although 800° C. or higher, and 1,200° C. or lower is preferable. Furthermore, it is preferable that a desired firing temperature is reached at the initial stage of the firing, and it is preferable that the temperature is raised to the firing temperature without stopping from the start of firing. The firing time can be about 12 hours. In this regard, the method for manufacturing the negative electrode active material for a nonaqueous secondary battery is not limited to the above-described steps. For example, another step may be added, or any one of the above-described steps may be omitted. For example, the adjustment step may be omitted and a commercially available mixed powder or the like may be used.

A nonaqueous secondary battery according to the present invention is provided with a negative electrode having the above-described negative electrode active material for a nonaqueous secondary battery according to the present invention, a positive electrode having a positive electrode active material, and an ionic conductive medium which is interposed between the positive electrode and the negative electrode and which conducts ions.

In the nonaqueous secondary battery according to the present invention, the negative electrode may be formed by, for example, applying a paste-like negative electrode material, which is produced by mixing a negative electrode active material, an electrically conductive material, and a binder and adding an appropriate solvent, to the surface of a collector, followed by drying and, as necessary, performing compression to increase the electrode density. The electrically conductive material is not specifically limited insofar as the electrically conductive material is an electron conductive material which does not adversely affect the battery performance of the negative electrode. For example, at least one type of graphite, e.g., natural graphite (flaky graphite, scaly graphite) and artificial graphite, acetylene black, carbon black, Ketjenblack, carbon whiskers, needle coke, carbon fibers, metals (copper, nickel, aluminum, silver, gold, and the like), and the like or a combination of at least two types thereof can be used. Among them, carbon black and acetylene black are preferable as the electrically conductive material from the viewpoint of the electron conductivity and coating performance. The binder performs a function of retaining active material particles and electrically conductive material particles. For example, fluorine-containing resins, e.g., polytetrafluoroethylene (PTFE), polyvinylidene fluoride (PVDF), and fluororubber, thermoplastic resins, e.g., polypropylene and polyethylene, ethylene-propylene-diene monomer (EPDM), sulfonated EPDM, natural butyl rubber (NBR), and the like can be used alone or at least two types can be used in combination. Alternatively, cellulose based binders, styrene butadiene rubber (SBR) water dispersion, and the like, which serve as aqueous binders, can also be used. As for the solvent to disperse the negative electrode active material, electrically conductive material, and the binder, for example, organic solvents, e.g., N-methylpyrrolidone, dimethylformamide, dimethylacetamide, methyl ethyl ketone, cyclohexanone, methyl acetate, methyl acrylate, diethyltriamine, N,N-dimethylaminopropylamine, ethylene oxide, and tetrahydrofuran, can be used. Alternatively, a dispersing agent, a thickener, and the like may be added to water, and an active material may be slurried with latex, e.g., SBR. As for the thickener, for example, polysaccharide, e.g., carboxymethylcellulose and methylcellulose, can be used alone or at least two types can be used in combination. Examples of coating methods include roller coating, e.g., an applicator roll, screen coating, a doctor blade system, spin coating, and a bar coater. Desired thickness and shape can be achieved by using any one of them. As for the collector, aluminum, copper, or the like having the surface treated with carbon, nickel, titanium, silver or the like can be used besides aluminum, titanium, stainless steel, nickel, iron, fired carbon, electrically conductive polymer, electrically conductive glass, or the like for the purpose of improving the adhesion, the electrical conductivity, and the oxidation resistance. Regarding them, the surface can be subjected to an oxidation treatment. Examples of shapes of the collector include the shape of foil, the shape of a film, the shape of a sheet, the shape of a net, a punched or expanded body, a lath body, a porous body, a foamed body, and a fiber group-formed body.

In the nonaqueous secondary battery according to the present invention, the positive electrode may be formed by, for example, applying a paste-like positive electrode material, which is produced by mixing a positive electrode active material, an electrically conductive material, and a binder and adding an appropriate solvent, to the surface of a collector, followed by drying and, as necessary, performing compression to increase the electrode density. As for the positive electrode active material, those which can function in the case where the negative electrode active material for a nonaqueous secondary battery according to the present invention is used for the negative electrode, are employed. For example, LiCoO₂, LiNiO₂, LiNi_{0.5}Mn_{0.5}O₂, and the like having a layered rock salt structure, LiMn₂O₄ and the like having a spinel structure, and LiFePO₄ and the like of polyanion base can be used. In particular, those having a layered rock salt structure are preferable. Furthermore, it is preferable that a function (oxidation, reduction) can be performed at 3.0 V or more with reference to lithium, it is more preferable that the function can be performed at 3.5 V or more, and it is further preferable that the function can be performed at 4.0 V or more. By the way, as for each of the electrically conductive material, the binder, the collector, the solvent, and the like, those exemplified with respect to the negative electrode can be used appropriately.

In the nonaqueous secondary battery according to the present invention, as for the nonaqueous ionic conductive medium, a nonaqueous electrolytic solution or an ionic liquid in which a supporting electrolyte is dissolved in an organic solvent, a gel electrolyte, a solid electrolyte, or the like can be used. Among them, the nonaqueous electrolytic solution is preferable. As for the supporting electrolyte, for example, known supporting electrolytes, e.g., LiPF₆, LiClO₄, LiAsF₆, LiBF₄, Li(CF₃SO₂)₂N, Li(CF₃SO₃), and LiN(C₂F₅SO₂), can be used. It is preferable that the concentration of the supporting electrolyte is 0.1 to 2.0 M, and 0.8 to 1.2 M is more preferable. Examples of organic solvents include organic solvents, e.g., ethylene carbonate (EC), propylene carbonate (PC), γ-butyrolactone (γ-BL), diethyl carbonate (DEC), and dimethyl carbonate (DMC), which are used for conventional secondary batteries and capacitors. They may be used alone or a plurality of them may be used in combination. Furthermore, the ionic liquid is not specifically limited, and 1-methyl-3-propylimidazolium bis(trifluorosulfonyl)imide, 1-ethyl-3-butylimidazolium tetrafluoroborate, and the like can be used. The gel electrolyte is not specifically limited, Examples include gel electrolytes produced by including an electrolyte containing a supporting electrolyte in polymers, e.g., polyvinylidene fluoride, polyethylene glycol, and polyacrylonitrile, or saccharide, e.g., amino acid derivatives and sorbitol derivatives. Examples of solid electrolytes include inorganic solid electrolytes and organic solid electrolytes. As for the inorganic solid electrolytes, for example, nitrides, halides, oxysalts, and the like of Li are well known. Most of all, LiSiO₄, Li₄SiO₄⁻ LiI—LiOH, xLi₃PO₄-(1-x)Li₄SiO₄, Li₂SiS₃, Li₃PO₄—Li₂S—SiS₂, phosphorus sulfide compounds, and the like are mentioned. They may be used alone or a plurality of them may be used in combination. Examples of organic solid electrolytes include polyethylene oxides, polypropylene oxides, polyvinyl alcohols, polyvinylidene fluorides, polyphosphazenes, polyethylene sulfides, polyhexafluoropropylenes, and derivatives thereof. They may be used alone or a plurality of them may be used in combination.

A lithium secondary battery according to the present invention may be provided with a separator between a negative electrode and a positive electrode. The separator is not specifically limited insofar as the composition can endure within the range of use of the secondary battery. Examples thereof include polymer nonwoven fabrics, e.g., polypropylene nonwoven fabrics and polyphenylene sulfide nonwoven fabrics, and microporous films of olefin based resins, e.g., polyethylenes and polypropylenes. They may be used alone or a plurality of them may be used in combination.

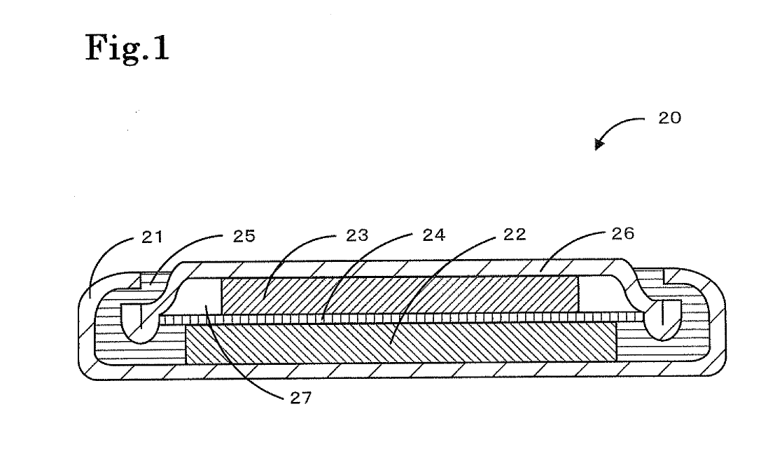

The shape of the lithium secondary battery according to the present invention is not specifically limited. Examples thereof include coin type, button type, sheet type, lamination type, cylindrical type, flat type, and rectangular type. Moreover, application to a large scale product or the like used for an electric car or the like may be performed. An example of this lithium secondary battery is shown in FIG. 1. FIG. 1 is a sectional view schematically showing the configuration of a coin type battery 20. This coin type battery 20 is provided with a cup-shaped battery case 21, a positive electrode 22 disposed in the inside of this battery case 21, a negative electrode 23 disposed at a location opposite to the positive electrode 22 with a separator 24 therebetween, a nonaqueous electrolytic solution 27 containing a supporting electrolyte, a gasket 25 formed from an insulating material, and an opening-sealing plate 26, which is disposed at an opening portion of the battery case 21 and which seals the battery case 21 with the gasket 25 therebetween. Here, the negative electrode 23 includes an oxide represented by a basic composition LiNi₁₋ₓMnₓO₂ (0<x<0.5) as a negative electrode active material.

The present invention is not limited to the above embodiment. Various modifications may be made within the technical scope of the present invention.

For example, in the above-described embodiment, the negative electrode active material for a nonaqueous secondary battery is described, although it may be the explanation of the using method of this negative electrode active material for a nonaqueous secondary battery. That is, the using method according to the present invention is a using method in which an oxide represented by a basic composition LiNi₁₋ₓMnₓO₂ (0<x<0.5) is used as a negative electrode active material for a nonaqueous secondary battery. According to this using method, charge and discharge can be performed and it is possible to function as a battery. At this time, it is believed that lithium ions are inserted into the oxide while the form of oxygen array is changed from a cubic close-packed oxygen array of LiNi₁₋ₓMnₓO₂ to a hexagonal close-packed oxygen array of Li₂Ni₁₋ₓMnₓO₂, and it is believed that the actuation potential is about 1 to 2 V with reference to lithium. In the using method according to the present invention, preferably, usage is performed within the range, in which the potential of the negative electrode at the time when the charge is stopped becomes 0.8 V or more, and 1.2 V or less with reference to a lithium metal and the potential of the negative electrode at the time when the discharge is stopped becomes 2.7 V or more, and 3.4 V or less with reference to the lithium metal. In this regard, the oxide may adopt any one of the above-described forms in this using method.

### EXAMPLES

Examples, in which the negative electrode active material for a nonaqueous secondary battery was specifically produced, will be described as experimental examples below.

### Experimental Example 1

### Synthesis of Negative Electrode Active Material for a Nonaqueous Secondary Battery

A negative electrode active material represented by a composition formula LiNi_{0.67}Mn_{0.33}O₂ was synthesized as described below. Initially, NiO, MnO, and LiOH, which served as raw materials, were weighed and formulated in such a way that the composition after firing became LiNi_{0.67}Mn_{0.33}O₂ and were put into pots of a planetary ball mill (p-6, Fritsch Japan Co., Ltd.). Subsequently, zirconia balls and a precursor were put into a zirconia container of the ball mill at a weight ratio adjusted to be 40:1, ethanol was added up to about two-thirds of the zirconia container, and a treatment was performed for 24 hours while the number of revolutions of the revolution was specified to be 200 rpm and the ratio of the revolution to the rotation was specified to be 1.25, so as to prepare a slurry-like precursor. In this regard, this apparatus was able to apply a high centrifugal force to balls in the pot by placing two pots on a table which revolved and the revolution and the rotation were effected at the same time through the use of gears. The mechanical alloying method with this planetary ball mill was able to perform nano-order control of the mixing of constituent elements. The thus obtained slurry-like precursor was concentrated and dried with a rotary evaporator (R-215V, Nihon BUCHI K.K.) and was dried for a night in an oven at 100° C., so as to obtain a precursor powder. Then, the resulting precursor powder was pressure-formed into the pellets having a diameter of about 2 cm and a thickness of about 5 mm, and was fired in an oxidizing atmosphere, so that a negative electrode active material of Experimental example 1 was obtained. Regarding the firing, the optimum firing temperature was different depending on the composition, although the temperature was raised to 800° C. to 1,000° C. in an electric furnace without stopping, and the mixture was fired at that temperature for 12 hours, so that the negative electrode active material for a nonaqueous secondary battery of Experimental example 1 was obtained.

### [X-Ray Diffraction Measurement]

Regarding the resulting negative electrode active material for a nonaqueous secondary battery, a powder X-ray diffraction measurement was performed. The measurement was performed with an X-ray diffractometer (RINT2200, Rigaku Corporation) by using a CuKa ray (wavelength 1.54051 Å) as radiation. As for monochromatization of the X-ray, a graphite single crystal monochrometer was used, and the measurement was performed while the applied voltage was set at 40 kV and the current was set at 30 mA. In this regard, the measurement was performed at a scanning speed of 3°/min and recording was performed within the angle range of 10° to 100° (2θ). In the case where the measurement was performed with the CuKα ray, the diffraction peak which appeared at 2θ=about 18° to 20° was a (003) diffraction peak attributed to a hexagonal system of the space group R3m, and the diffraction peak which appeared at 28=about 44° to 45° was a (104) diffraction peak. The area intensity I(003) of the (003) diffraction peak and the area intensity I(104) of the (104) diffraction peak were calculated and the area intensity ratio I(003)/I(104) was calculated. Furthermore, the distance D (A) between transition metal layers was calculated from the diffraction angles of the individual diffraction peaks and the Miller index through optimization by using a least square method.

### [Production of Bipolar Evaluation Cell]

A working electrode was produced as described below. Initially, 85 percent by weight of negative electrode active material for a nonaqueous secondary battery produced as described above, 5 percent by weight of carbon black serving as an electrically conductive material, and 10 percent by weight of polyvinylidene fluoride serving as a binder were mixed. An appropriate amount of N-methyl-2-pyrrolidone (NMP) serving as a dispersing agent was added and dispersed, so as to produce a slurry-like mix. The resulting slurry-like mix was applied uniformly to a copper foil collector having a thickness of 10 μm and was heat-dried, so as to obtain a coating sheet. The resulting coating sheet was subjected to a pressure treatment and was stamped into an area of 2.05 cm², so that a disk-shaped electrode was prepared. As for an ionic conductive medium, a nonaqueous electrolytic solution was used, in which lithium hexafluorophosphate was added to become 1 mol/l to nonaqueous solvent produced by mixing ethylene carbonate and diethyl carbonate at a volume ratio of 30:70. The above-described negative electrode was used as a working electrode, and lithium metal foil (thickness 300 μm) was used as a counter electrode, a separator (TOKEN TAPYRUS CO., LTD.) impregnated with the above-described nonaqueous electrolytic solution was sandwiched between the two electrodes and, thereby, a bipolar evaluation cell was produced.

### [Charge and Discharge Test]

The resulting bipolar evaluation cell was used. After reduction (charge) to 0.9 V was effected at 0.1 C (0.3 mA) in a temperature environment of 20° C., oxidation (discharge) was effected to 3.0 V at 0.1 C. The first reduction capacity Q(1st)red and the first oxidation capacity Q(1st)oxi of this charge and discharge operation were measured and the proportion (%) of irreversible capacity at the initial charge and discharge, which was represented by Rirrev=[(Q(1st)red Q(1st)oxi)/Q(1st)red×100], was calculated. Furthermore, this charge and discharge operation were repeated 10 times, the tenth oxidation capacity Q(10th)oxi was measured, and the oxidation capacity maintenance factor represented by the proportion of Q(10th)oxi to Q(1st)oxi, that is, Rcyc=[Q(10th)oxi/Q(1st)oxi×100], was determined.

### [Measurement of X-Ray Absorption Fine Structure]

Regarding the resulting negative electrode active material for a nonaqueous secondary battery, the X-ray absorption fine structure was measured, and the formal oxidation number was determined, which was derived from the energy of X-ray spectrum corresponding to the amount of absorption of 0.5, where the amount of absorption of an absorption local maximum value at the K absorption edge was assumed to be 1. Here, Li₂MnO₃ was used as the reference sample of tetravalent Mn (Mn⁴⁺), layered structure LiMnO₂ was used as the reference sample of trivalent Mn (Mn³⁺), LiCO_{0.5}Ni_{0.5}O₂ was used as the reference sample of trivalent Ni (Ni³⁺), and LiCO_{1/3}Ni_{1/3}Mn_{1/3}O₂ was used as the reference sample of divalent Ni (Ni²⁺) and Mn⁴⁺. This measurement of X-ray absorption fine structure was performed with respect to Experimental examples 1 to 7. In this regard, analytical techniques, e.g., XPS, may be used as the method for measuring the oxidation number of the transition metal ion. However, the measurement range of the XPS is limited to a material surface and, therefore, the oxidation number of the whole material cannot be acquired. Consequently, the X-ray absorption fine structure, from which the oxidation number of the whole active material was able to be examined, was measured, and the oxidation number was calculated from the energy of X-ray spectrum corresponding to the amount of absorption of 0.5, where the amount of absorption of an absorption local maximum value at the K absorption edge was assumed to be 1.

### Experimental Examples 2 to 5

A negative electrode active material of Experimental example 2 was produced as in Experimental example 1 except that raw materials were formulated in such a way as to allow the composition after firing to become LiNi_{0.75}Mn_{0.25}O₂, and was evaluated. Furthermore, a negative electrode active material of Experimental example 3 was produced as in Experimental example 1 except that raw materials were formulated in such a way as to allow the composition after firing to become LiNi_{0.6}Mn_{0.4}O₂, and was evaluated. Furthermore, a negative electrode active material of Experimental example 4 was produced as in Experimental example 1 except that raw materials were formulated in such a way as to allow the composition after firing to become LiNi_{0.85}Mn_{0.15}O₂, and was evaluated. Furthermore, a negative electrode active material of Experimental example 5 was produced as in Experimental example 1 except that raw materials were formulated in such a way as to allow the composition after firing to become LiNi_{0.9}Mn_{0.1}O₂, and was evaluated.

### Experimental Examples 6 and 7

A negative electrode active material of Experimental example 6 was produced as in Experimental example 1 except that raw materials were formulated in such a way as to allow the composition after firing to become LiNi_{0.5}Mn_{0.5}O₂, and was evaluated. Furthermore, a negative electrode active material of Experimental example 7 was produced as in Experimental example 1 except that raw materials were formulated in such a way as to allow the composition after firing to become LiNiO₂, and was evaluated.

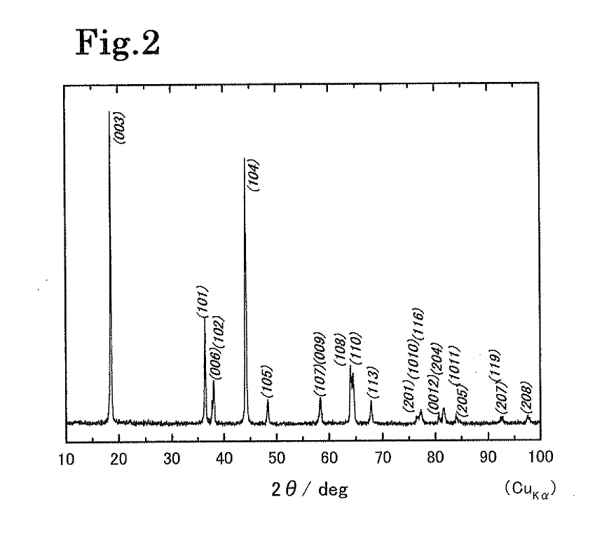

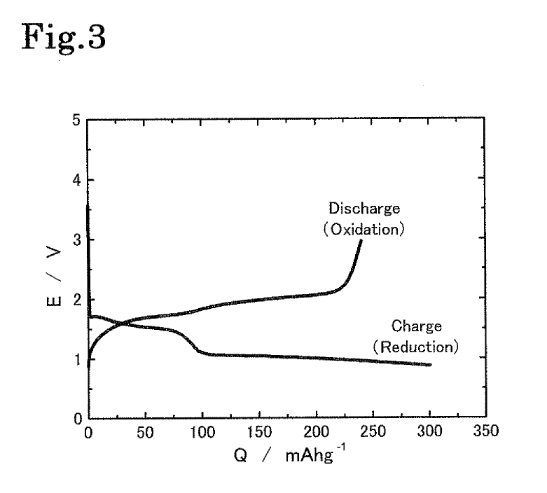

FIG. 2 shows the X-ray diffraction pattern of the negative electrode active material for a nonaqueous secondary battery of Experimental example 1. Here, the peak area intensity ratio I(003)/I(104) was 0.94. FIG. 3 shows a charge-discharge curve of the first cycle of the negative electrode active material for a nonaqueous secondary battery of Experimental example 1. It was made clear from FIG. 3 that the negative electrode active material of Experimental example 1 was able to function (oxidation•reduction) within the range of 0.9 V or more, and 3.0 V or less with reference to lithium, and was able to be used as a negative electrode. Table 1 shows the initial oxidation capacity, the proportion of irreversible capacity, and the oxidation capacity maintenance factor of Experimental examples 1 to 7. It was made clear that in Experimental examples 1 to 5 represented by LiNi₁₋ₓMnₓO₂ (0<x<0.5), the initial oxidation capacity was at the same level, the proportion of irreversible capacity was small, and the oxidation capacity maintenance factor was large as compared with those in Experimental example 7 represented by LiNiO₂. Moreover, it was made clear that in Experimental examples 1 to 5 represented by LiNi₁₋ₓMnₓO₂ (0<x<0.5), the initial oxidation capacity was large, the proportion of irreversible capacity was small, and the oxidation capacity was large as compared with those in Experimental example 6 represented by LiNi_{0.5}Mn_{0.5}O₂. Consequently, it was made clear that the oxide having the basic composition represented by LiNi₁₋ₓMnₓO₂ (0<x<0.5) was preferable as the negative electrode active material for a nonaqueous secondary battery.

TABLE 1

| | Composition | Q(1st)oxi | Rirrev | Rcyc |
|---|---|---|---|---|
| | formula | mAh/g | % | % |
| Experimental | LiNi_{0.67}Mn_{0.33}O₂ | 240 | 20.3 | 72.6 |
| example 1 | | | | |
| Experimental | LiNi_{0.75}Mn_{0.25}O₂ | 239 | 19.3 | 68.2 |
| example 2 | | | | |
| Experimental | LiNi_{0.60}Mn_{0.40}O₂ | 224 | 29.2 | 59.1 |
| example 3 | | | | |
| Experimental | LiNi_{0.85}Mn_{0.15}O₂ | 242 | 33.4 | 41.2 |
| example 4 | | | | |
| Experimental | LiNi_{0.90}Mn_{0.10}O₂ | 244 | 37.4 | 35.2 |
| example 5 | | | | |
| Experimental | LiNi_{0.50}Mn_{0.50}O₂ | 146 | 69.4 | 28.2 |
| example 6 | | | | |
| Experimental | LiNiO₂ | 256 | 40.2 | 20.1 |
| example 7 | | | | |

 Q(1st)oxi: First oxidation capacity of charge and discharge operation
 Rirrev = (Q(1st)red − Q(1st)oxi)/Q(1st)red × 100
 Rcyc = Q(10th)oxi/Q(1st)oxi × 100

### Experimental Examples 8 and 9

A negative electrode active material of Experimental example 8 was produced as in Experimental example 1 except that the time of the ball mill treatment was specified to be 4 hours (it is estimated that mixing of Ni and Mn was insufficient), and was evaluated. Furthermore, a negative electrode active material of Experimental example 9 was produced as in Experimental example 2 except that the time of the ball mill treatment was specified to be 4 hours, and was evaluated.

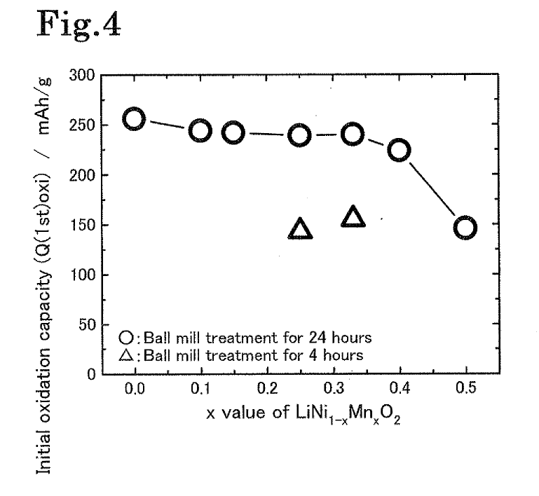

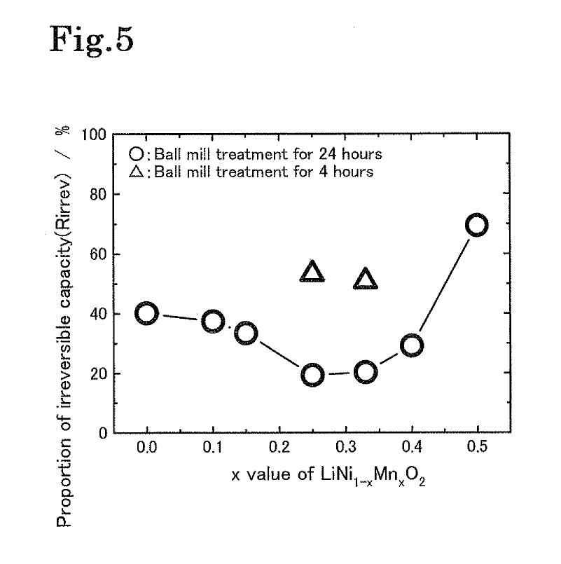

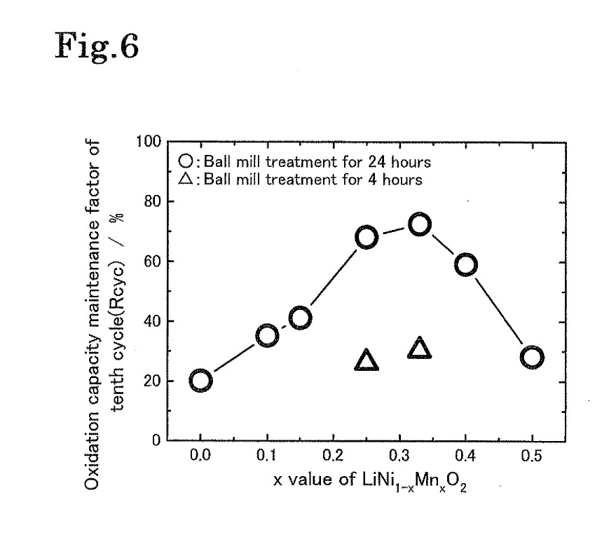

FIG. 4 is a graph showing the relationship between the x value of LiNi₁₋ₓMnₓO₂ and the initial oxidation (discharge) capacity. FIG. 5 is a graph showing the relationship between the x value of LiNi₁₋ₓMnₓO₂ and the proportion of irreversible capacity. FIG. 6 is a graph showing the relationship between the x value of LiNi₁₋ₓMnₓO₂ and the oxidation (discharge) capacity maintenance factor. In FIGS. 4, 5, and 6, the case where the time of the ball mill treatment was 24 hours is indicated by a symbol 0, and the case where the time of the ball mill treatment was 4 hours is indicated by a symbol A. According to this, it was made clear that in particular in the case of the same composition, the ball mill treatment time of a long 24 hours was preferable because the initial oxidation capacity was large, the proportion of initial irreversible capacity was small, and the oxidation capacity maintenance factor was large. Table 2 shows the initial oxidation capacity, the proportion of initial irreversible capacity, and the oxidation capacity maintenance factor of Experimental examples 1, 2, 8, and 9.

TABLE 2

| | | Time of | | | |
|---|---|---|---|---|---|
| | Composition | treatment | Q(1st)oxi | Rirrev | Rcyc |
| | formula | hour | mAh/g | % | % |
| Experimental | LiNi_{0.67}Mn_{0.33}O₂ | 24 | 240 | 20.3 | 72.6 |
| example 1 | | | | | |
| Experimental | LiNi_{0.75}Mn_{0.25}O₂ | 24 | 239 | 19.3 | 68.2 |
| example 2 | | | | | |
| Experimental | LiNi_{0.67}Mn_{0.33}O₂ | 4 | 143 | 53.2 | 26.3 |
| example 8 | | | | | |
| Experimental | LiNi_{0.75}Mn_{0.25}O₂ | 4 | 155 | 50.8 | 30.4 |
| example 9 | | | | | |

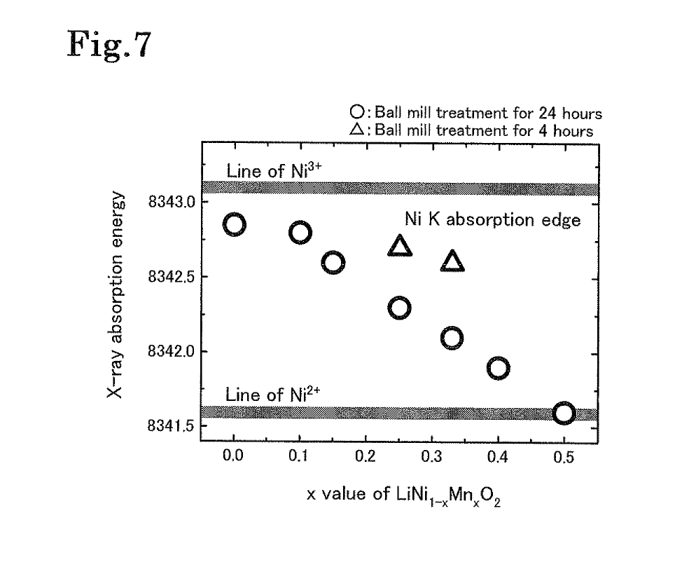

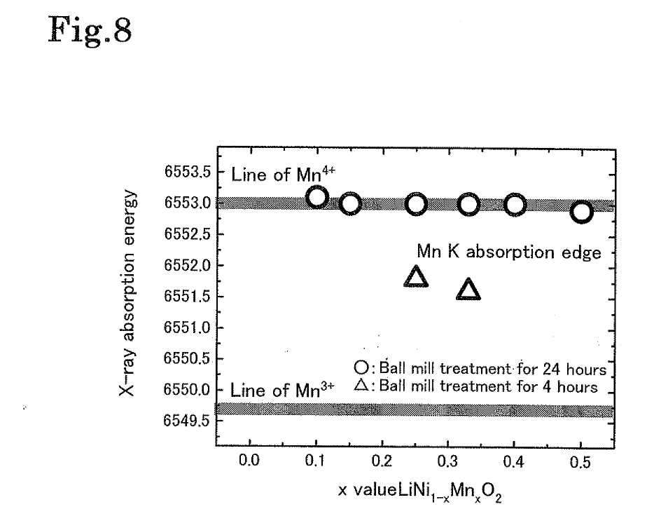

FIG. 7 is a graph showing the relationship between the x value of LiNi₁₋ₓMnₓO₂ and the energy at an X-ray spectrum of NiK absorption edge. FIG. 8 is a graph showing the relationship between the x value of LiNi₁₋ₓMnₓO₂ and the energy at an X-ray spectrum of MnK absorption edge. In FIGS. 7 and 8, the case where the time of the ball mill treatment was 24 hours is indicated by a symbol 0, and the case where the time of the ball mill treatment was 4 hours is indicated by a symbol A. In FIG. 7, the energy of the Ni³⁺ line was calculated from LiCo_{0.5}Ni_{0.5}O₂, and the Ni²⁺ line was calculated from LiCo_{1/3}Ni_{1/3}Mn_{1/3}O₂. In FIG. 8, the energy of the Mn⁴⁺ line was calculated from Li₂MnO₃ and LiCO_{1/3}Ni_{1/3}Mn_{1/3}O₂, and the Mn³⁺ line was calculated from layered structure LiMnO₂. In Experimental example 6, LiNi_{0.5}Mn_{0.5}O₂ was composed of a combination of Ni²⁺ and Mn⁴⁺, and in Experimental example 7, LiNiO₂ contained a very small amount of Ni²⁺ in addition to Ni³⁺. Furthermore, in Experimental examples 8 and 9, in which the ball mill treatment time was specified to be 4 hours and it was believed that mixing of nickel and manganese was insufficient, Ni²⁺, Ni³⁺, Mn³⁺, and Mn⁴⁺ were combined. On the other hand, it was made clear that Ni²⁺, Ni³⁺, and Mn⁴⁺ were combined in Experimental examples 1 to 5. Regarding Experimental examples 1 to 5, in which Ni²⁺, Ni³⁺, and Mn⁴⁺ were combined, the initial oxidation capacity was large, the proportion of initial irreversible capacity was small, and the oxidation capacity maintenance factor was large and, therefore, it was estimated that there was a correspondence relationship among them. Consequently, it was made clear that preferably, the negative electrode active material for a nonaqueous secondary battery was an oxide represented by the basic composition LiNi₁₋ₓMnₓO₂ (0<x<0.5), the ball mill treatment time was specified to be 24 hours, the valence of Ni in the oxide was specified to be 2 and 3, and the valence of Mn was specified to be 4. In this regard, it was estimated that in the case where Ni and Mn in the negative electrode active material represented by the composition formula LiNi₁₋ₓMnₓO₂ (0<x<0.5) were composed of Ni²⁺, N³⁺, and Mn⁴⁺, when Ni²⁺ performed function of stabilizing the layered structure, and Mn⁴⁺ contributed to the oxidation reduction reaction, the change in the oxygen array from the cubic close packing to the hexagonal close packing was facilitated by the effect of Jahn-Teller strain of Ni³⁺. On the other hand, was estimated that regarding the material in which mixing of nickel and manganese in the crystal lattice was insufficient, Ni and Mn were composed of Ni²⁺, Ni³⁺, Mn³⁺, and Mn⁴⁺ and the layered structure was destabilized by presence of Mn³⁺ in the lattice.

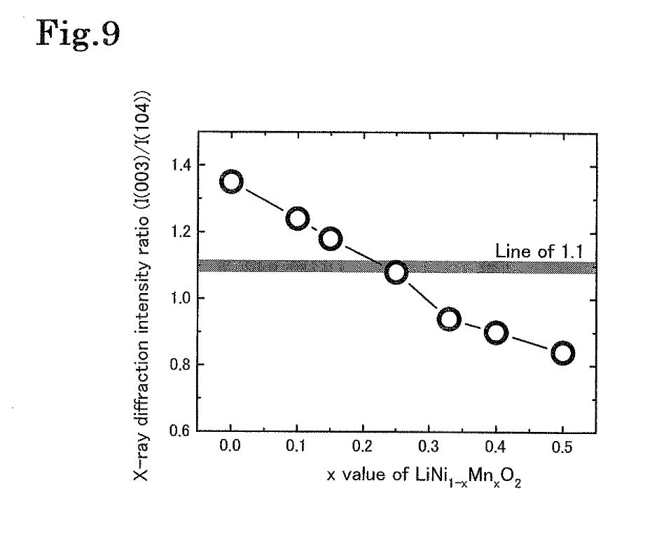

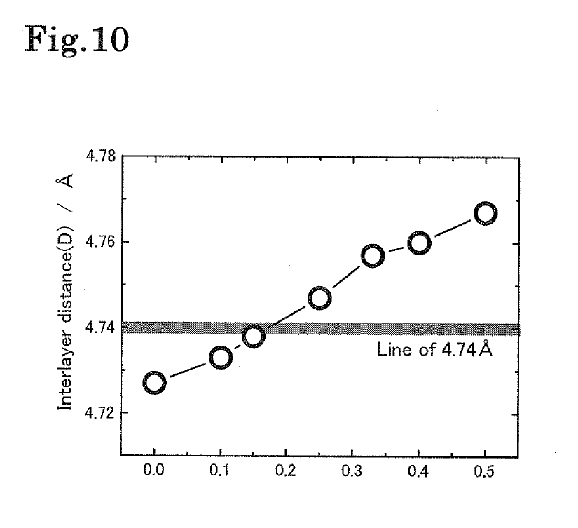

FIG. 9 is a graph showing the relationship between the x value of LiNi₁₋ₓMnₓO₂ and the peak area intensity ratio I(003)/I(104). Regarding LiNi_{0.67}Mn_{0.33}O₂ in Experimental example 1, LiNi_{0.75}Mn_{0.25}O₂ in Experimental example 2, and LiNi_{0.6}Mn_{0.4}O₂ in Experimental example 3, which satisfy I(003)/I(104)<1.1, the proportion of irreversible capacity was small, the initial oxidation capacity was large, and excellent charge-discharge behavior was exhibited (refer to FIGS. 5 and 6). Furthermore, LiNi_{0.85}Mn_{0.15}O₂ and LiNi_{0.75}Mn_{0.25}O₂ were compared, where the area intensity ratio I(003)/I(104) straddles the boundary line of I(003)/I(104)≦1.1, and it was made clear that the charge-discharge behavior was sharply improved at the composition of LiNi_{0.75}Mn_{0.25}O₂ (refer to FIGS. 5 and 6). FIG. 10 is a graph showing the relationship between the x value of LiNi₁₋ₓMnₓO₂ and the distance D between transition metal layers. Regarding LiNi_{0.67}Mn_{0.33}O₂ in Experimental example 1, LiNi_{0.75}Mn_{0.25}O₂ in Experimental example 2, and LiNi_{0.6}Mn_{0.4}O₂ in Experimental example 3, which satisfy D≧4.74, the proportion of irreversible capacity was small, the oxidation capacity was large, and excellent charge-discharge behavior was exhibited (refer to FIGS. 5 and 6). Furthermore, LiNi_{0.85}Mn_{0.15}O₂ and LiNi_{0.75}Mn_{0.25}O₂ were compared, where the boundary line of D 4.74 was straddled, and it was made clear that the charge-discharge behavior was sharply improved at the composition of LiNi_{0.75}Mn_{0.25}O₂ (refer to FIGS. 5 and 6). In this regard, it was estimated that when the area intensity ratio of the X-ray diffraction peak became I(003)/I(104) δ 1.1, transition metal ions were present partly in the lithium layer, they performed the function of pillars to support the transition metal layer and, thereby, the structural stability increased. In addition, it was estimated that the change in the oxygen array from the cubic close packing to the hexagonal close packing was not easily hindered because the distance between the transition metal layers in the layered structure satisfy D≧4.74 at that time. Table 3 shows the peak area intensity ratio I(003)/I(104) and the D value of Experimental examples 1 to 5 and Experimental examples 6 and 7.

TABLE 3

| | Composition | | I(003)/ |
|---|---|---|---|
| | formula | D value | I(104) |
| Experimental | LiNi_{0.67}Mn_{0.33}O₂ | 4.757 | 0.9 |
| example 1 | | | |
| Experimental | LiNi_{0.75}Mn_{0.25}O₂ | 4.747 | 1.1 |
| example 2 | | | |
| Experimental | LiNi_{0.60}Mn_{0.40}O₂ | 4.760 | 0.9 |
| example 3 | | | |
| Experimental | LiNi_{0.85}Mn_{0.15}O₂ | 4.738 | 1.2 |
| example 4 | | | |
| Experimental | LiNi_{0.90}Mn_{0.10}O₂ | 4.733 | 1.2 |
| example 5 | | | |
| Experimental | LiNi_{0.50}Mn_{0.50}O₂ | 4.767 | 0.8 |
| example 6 | | | |
| Experimental | LiNiO₂ | 4.727 | 1.4 |
| example 7 | | | |

 D value: Distance between transition metal layers having layered structure
 I(003)/I(104): integral intensity ratio of (003) diffraction peak to (104) diffraction peak attributed to hexagonal system of space group R3m

### Experimental Examples 10 to 12

A negative electrode active material of Experimental example 10 was produced as in Experimental example 1 except that Mg doping was performed and raw materials were formulated in such a way as to allow the composition after firing to become LiNi_{0.66}Mn_{0.33}Mg_{0.01}O₂, and was evaluated. Furthermore, a negative electrode active material of Experimental example 11 was produced as in Experimental example 10 except that raw materials were formulated in such a way as to allow the composition after firing to become LiNi_{0.63}Mn_{0.33}Mg_{0.04}O₂, and was evaluated. Furthermore, a negative electrode active material of Experimental example 12 was produced as in Experimental example 10 except that raw materials were formulated in such a way as to allow the composition after firing to become LiNi_{0.57}Mn_{0.33}Mg_{0.10}O₂, and was evaluated.

### Experimental Examples 13 and 14

A negative electrode active material of Experimental example 13 was produced as in Experimental example 10 except that raw materials were formulated in such a way as to allow the composition after firing to become LiNi_{0.663}Mn_{0.33}Mg_{0.007}O₂, and was evaluated. Furthermore, a negative electrode active material of Experimental example 14 was produced as in Experimental example 10 except that raw materials were formulated in such a way as to allow the composition after firing to become LiNi_{0.55}Mn_{0.33}Mg_{0.12}O₂, and was evaluated.

Table 4 shows the initial oxidation capacity, the proportion of initial irreversible capacity, and the oxidation capacity maintenance factor of Experimental examples 1, and 10 to 14.

TABLE 4

| | Composition | Q(1st)oxi | Rirrev | Rcyc |
|---|---|---|---|---|
| | formula | mAh/g | % | % |
| Experimental | LiNi_{0.67}Mn_{0.33}O₂ | 240 | 20.3 | 72.6 |
| example 1 | | | | |
| Experimental | LiNi_{0.66}Mn_{0.33}Mg_{0.01}O₂ | 237 | 18.7 | 75.9 |
| example 10 | | | | |
| Experimental | LiNi_{0.63}Mn_{0.33}Mg_{0.04}O₂ | 236 | 18.6 | 77.2 |
| example 11 | | | | |
| Experimental | LiNi_{0.57}Mn_{0.33}Mg_{0.10}O₂ | 237 | 18.6 | 77.6 |
| example 12 | | | | |
| Experimental | LiNi_{0.663}Mn_{0.33}Mg_{0.007}O₂ | 239 | 20.1 | 71.6 |
| example 13 | | | | |
| Experimental | LiNi_{0.55}Mn_{0.33}Mg_{0.12}O₂ | 229 | 24.5 | 67.9 |
| example 14 | | | | |

### Experimental Examples 15 to 17

A negative electrode active material of Experimental example 15 was produced as in Experimental example 1 except that Al doping was performed and raw materials were formulated in such a way as to allow the composition after firing to become LiNi_{0.665}Mn_{0.325}Al_{0.01}O₂, and was evaluated. Furthermore, a negative electrode active material of Experimental example 16 was produced as in Experimental example 15 except that raw materials were formulated in such a way as to allow the composition after firing to become LiNi_{0.65}Mn_{0.31}Al_{0.04}O₂ and was evaluated. Furthermore, a negative electrode active material of Experimental example 17 was produced as in Experimental example 15 except that raw materials were formulated in such a way as to allow the composition after firing to become LiNi_{0.62}Mn_{0.28}Al_{0.1}O₂, and was evaluated.

### Experimental Examples 18 and 19

A negative electrode active material of Experimental example 18 was produced as in Experimental example 17 except that raw materials were formulated in such a way as to allow the composition after firing to become LiNi_{0.666}Mn_{0.326}Al_{0.008}O₂, and was evaluated. Furthermore, a negative electrode active material of Experimental example 19 was produced as in Experimental example 17 except that raw materials were formulated in such a way as to allow the composition after firing to become LiNi_{0.61}Mn_{0.27}Al_{0.12}O₂, and was evaluated.

Table 5 shows the initial oxidation capacity, the proportion of initial irreversible capacity, and the oxidation capacity maintenance factor of Experimental examples 1, and 15 to 19.

TABLE 5

| | Composition | Q(1st)oxi | Rirrev | Rcyc |
|---|---|---|---|---|
| | formula | mAh/g | % | % |
| Experimental | LiNi_{0.67}Mn_{0.33}O₂ | 240 | 20.3 | 72.6 |
| example 1 | | | | |
| Experimental | LiNi_{0.665}Mn_{0.325}Al_{0.01}O₂ | 239 | 17.6 | 76.2 |
| example 15 | | | | |
| Experimental | LiNi_{0.65}Mn_{0.31}Al_{0.04}O₂ | 241 | 17.3 | 78.4 |
| example 16 | | | | |
| Experimental | LiNi_{0.62}Mn_{0.28}Al_{0.10}O₂ | 241 | 17.2 | 78.1 |
| example 17 | | | | |
| Experimental | LiNi_{0.666}Mn_{0.326}Al_{0.008}O₂ | 238 | 20.5 | 71.2 |
| example 18 | | | | |
| Experimental | LiNi_{0.61}Mn_{0.27}Al_{0.12}O₂ | 237 | 23.8 | 68.1 |
| example 19 | | | | |

### Experimental Examples 20 to 22

A negative electrode active material of Experimental example 20 was produced as in Experimental example 1 except that Co doping was performed and raw materials were formulated in such a way as to allow the composition after firing to become LiNi_{0.665}Mn_{0.325}Co_{0.01}O₂, and was evaluated. Furthermore, a negative electrode active material of Experimental example 21 was produced as in Experimental example 20 except that raw materials were formulated in such a way as to allow the composition after firing to become LiNi_{0.65}Mn_{0.31}CO_{0.04}O₂, and was evaluated. Furthermore, a negative electrode active material of Experimental example 22 was produced as in Experimental example 20 except that raw materials were formulated in such a way as to allow the composition after firing to become LiNi_{0.62}Mn_{0.28}Co_{0.1}O₂, and was evaluated.

### Experimental Examples 23 and 24

A negative electrode active material of Experimental example 23 was produced as in Experimental example 20 except that raw materials were formulated in such a way as to allow the composition after firing to become LiNi_{0.666}Mn_{0.326}CO_{0.008}O₂, and was evaluated. Furthermore, a negative electrode active material of Experimental example 24 was produced as in Experimental example 20 except that raw materials were formulated in such a way as to allow the composition after firing to become LiNi_{0.61}Mn_{0.27}CO_{0.12}O₂, and was evaluated.

Table 6 shows the initial oxidation capacity, the proportion of initial irreversible capacity, and the oxidation capacity maintenance factor of Experimental examples 1, and 20 to 24.

TABLE 6

| | Composition | Q(1st)oxi | Rirrev | Rcyc |
|---|---|---|---|---|
| | formula | mAh/g | % | % |
| Experimental | LiNi_{0.67}Mn_{0.33}O₂ | 240 | 20.3 | 72.6 |
| example 1 | | | | |
| Experimental | LiNi_{0.665}Mn_{0.325}Co_{0.01}O₂ | 239 | 18.1 | 77.2 |
| example 20 | | | | |
| Experimental | LiNi_{0.65}Mn_{0.31}Co_{0.04}O₂ | 242 | 17.8 | 78.2 |
| example 21 | | | | |
| Experimental | LiNi_{0.62}Mn₀₂₈Co_{0.10}O₂ | 241 | 17.7 | 77.9 |
| example 22 | | | | |
| Experimental | LiNi_{0.666}Mn_{0.326}Co_{0.008}O₂ | 238 | 20.9 | 70.9 |
| example 23 | | | | |
| Experimental | LiNi_{0.61}Mn_{0.27}Co_{0.12}O₂ | 238 | 24.2 | 67.2 |
| example 24 | | | | |

It was made clear from Tables 4 to 6 that an effect of doping appeared with respect to all of Mg, Al, and Co in the case where the amount of doping was 1.0 percent by mole or more, and 10 percent by mole or less. Specifically, no change was observed in the initial oxidation capacity (Q(1st)oxi), but it was made clear that the proportion of irreversible capacity (Rirrev) was reduced and the oxidation capacity maintenance factor (Rcyc) was improved. In this regard, it was estimated that with respect to the above-described different type element doping, magnesium in the form of Mg²⁺ was substituted for Ni²⁺ in the crystal lattice, aluminum and cobalt in the forms of Al³⁺ and Co³⁺ were substituted for Ni³⁺ and, thereby, the change in the oxygen array from the cubic close packing to the hexagonal close packing was facilitated.

In all Experimental examples, charge and discharge were able to be performed. However, in Experimental example 6, the proportion of irreversible capacity was particularly high, and in Experimental example 7, the oxidation capacity maintenance factor was particularly low. On the other hand, in Experimental examples 8 and 9, the proportion of irreversible capacity was lower than that of Experimental example 6, and the oxidation capacity maintenance factor was higher than that of Experimental example 7. Furthermore, in Experimental examples 1 to 5 and 10 to 24, each of the initial oxidation capacity, the proportion of irreversible capacity, and the oxidation capacity maintenance factor was good. Most of all, in Experimental examples 10 to 12, 15 to 17, and 20 to 22, the proportion of irreversible capacity was reduced and the oxidation capacity maintenance factor was improved.

The present application claims the benefit of the priority from Japanese Patent Application No. 2009-284049 filed on Dec. 15, 2009, the entire contents of which are incorporated herein by reference.

What is claimed is:

1. A negative electrode active material for a nonaqueous secondary battery, represented by a basic composition LiNi₁₋ₓMnₓO₂ (0<x<0.5).

2. The negative electrode active material for a nonaqueous secondary battery according to claim 1, wherein the valence of Ni is 2 and 3, and the valence of Mn is 4.

3. The negative electrode active material for a nonaqueous secondary battery according to claim 1, wherein 1.0 percent by mole or more, and 10 percent by mole or less of the total amount of Ni and Mn in the basic composition is substituted by at least one of Mg, Al, and Co.

4. The negative electrode active material for a nonaqueous secondary battery according to claim 1, wherein the peak area intensity ratio of the (003) face to the (104) face of the X-ray diffraction peak satisfies I(003)/I(104) 1.1, where the space group is assumed to be R3m.

5. A nonaqueous secondary battery comprising:
a negative electrode having the negative electrode active material according to claim 1;
a positive electrode having a positive electrode active material; and
an ionic conductive medium which is interposed between the positive electrode and the negative electrode and which conducts ions.

6. A using method comprising the step of using an oxide, which is represented by a basic composition LiNi₁₋ₓMnₓO₂ (0<x<0.5), as a negative electrode active material for a nonaqueous secondary battery.

7. The using method according to claim 6, wherein the valence of Ni is 2 and 3, and the valence of Mn is 4 in the oxide.

8. The using method according to claim 6, wherein 1.0 percent by mole or more, and 10 percent by mole or less of the total amount of Ni and Mn in the basic composition of the oxide is substituted by at least one of Mg, Al, and Co.

9. The using method according to claim 6, wherein the peak area intensity ratio of the (003) face to the (104) face of an X-ray diffraction peak of the oxide satisfies I(003)/I(104) 1.1, where the space group is assumed to be R3m.
